(19) United States
(12) Patent Application Publication
(10) Pub. No.: US 2023/0249948 A1
(43) Pub. Date: Aug. 10, 2023

(54) LIFTING APPARATUS AND METHOD FOR TRANSFERRING LOADS

(71) Applicant: RAM LIFTING TECHNOLOGIES PTE LTD, Singapore (SG)

(72) Inventor: Manivannan CHELLAPPA, Singapore (SG)

(73) Assignee: RAM LIFTING TECHNOLOGIES PTE LTD, Singapore (SG)

(21) Appl. No.: 18/004,703

(22) PCT Filed: Jul. 8, 2021
(86) PCT No.: PCT/SG2021/050401

§ 371 Date: Jan. 9, 2023

(30) Foreign Application Priority Data
Jul. 8, 2020 (SG) 10202006581R

(51) Int. Cl. B66C 1/16; B66C 1/10; B66C 23/76; B66F 9/19

(52) U.S. Cl. CPC B66C 1/16; B66C 1/101; B66C 23/76; B66F 9/19; B66C 2700/082

(57) ABSTRACT

A lifting rig includes a cradle and a load transfer device. The load transfer device is arranged to draw in a payload to the cradle or deliver a payload from the cradle. The lifting rig is arranged to be lifted to an elevated space and the load transfer device is arranged to draw in or deliver the payload within the elevated space.

### FIELD OF THE INVENTION

This invention relates to load lifting operations with cranes. Particularly, it relates to the transfer of loads in or out of roofed spaces. ‘Roofed space’ in this disclosure refers to a situation with overhead restrictions that block direct vertical lifting or landing of the load.

### BACKGROUND

Practitioners rely on various methods to transfer loads to and from roofed spaces. The safest method is using a cantilevered beam mounted on the ceiling above the roofed space, the beam extending beyond the edge. A chain block coupled to a trolley travels along the beam length and lifts the load to a sufficient before it is pulled into the roofed space. Such hoisting beams are useful for equipment transfers in and out of the specific floor and many completed buildings maintain a permanent one to assist equipment repair or replacement after commissioning. However, weight support being offset from the plumbline of the lift, load capacity is severely limited making this method expensive and time consuming for installation for use in a multitude of roofed spaces in an ongoing project.

Many options are not suitable for extremely heavy items such as building chillers, generators, and large transformers. These are usually hoisted into position on high floors before the roof is constructed. Then, if necessary, site owners engage professional crew with mobile lifting pods for repair and replacement of these items at higher floors of completed buildings. However, there are logistical and safety issues in using mobile pods.

OSHA (Occupational Safety and Health Administration) safe lifting regulations require that the load is lashed and held solidly on the platform during lifting. Typically, the crew boards the suspended pod docked at target floor to insert or remove skates for lateral shifting, and, to lash or unlash the load. Mounting the suspended pod makes the crew vulnerable to injury from falling objects, a hazard from which they have no realistic escape in an emergency. Consideration for crew access and egress also places limitations on the load size. The above factors combine to make the use of hoisting pods time a consuming process, causing heavy loads to be suspended at the target floor much longer than necessary.

### SUMMARY OF INVENTION

In a first aspect, the invention provides a lifting rig comprising: a cradle and a load transfer device; the load transfer device is arranged to draw in a payload to the cradle or deliver a payload from the cradle; said lifting rig is arranged to be lifted to an elevated space and the load transfer device arranged to draw in or deliver the payload within the elevated space.

In a second aspect, the invention provides A method for lifting a payload to an elevated space, the method comprising the steps of: drawing in a payload to a cradle by a load transfer device mounted therein; lifting the cradle from a first level to the elevated space; delivering the payload to the elevated space by the load transfer device.

Thus, by providing a lifting rig having a cradle and a load transfer device, that is arranged to move relative to the cradle, this allows for load handling at a first level, for instance at street level, and at an elevated location. The load transfer device acts to draw in the payload to the cradle or deliver a payload from the cradle.

That elevated location may be a roofed space, with the lifting rig arranged to load or discharge a payload to the roofed space without crew mounting the rig at any time during the operation.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1A to 1C are sequential isometric views of a lifting rig in operation according to one embodiment of the present invention;

FIG. 2A is an isometric view of a lifting rig according to a further embodiment of the present invention;

FIGS. 2B to 2D are schematic views of the lifting rig according to various embodiments of the present invention;

FIG. 3 is an isometric view of a lifting rig according to a further embodiment of the present invention;

FIG. 4 is an isometric view of a lifting rig according to a further embodiment of the present invention, and; FIG. 5 is an isometric view of a lifting rig according to a further embodiment of the present invention.

### DETAILED DESCRIPTION

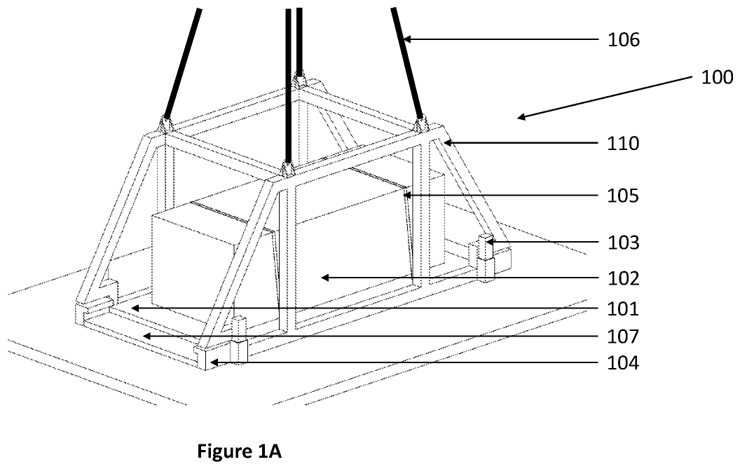

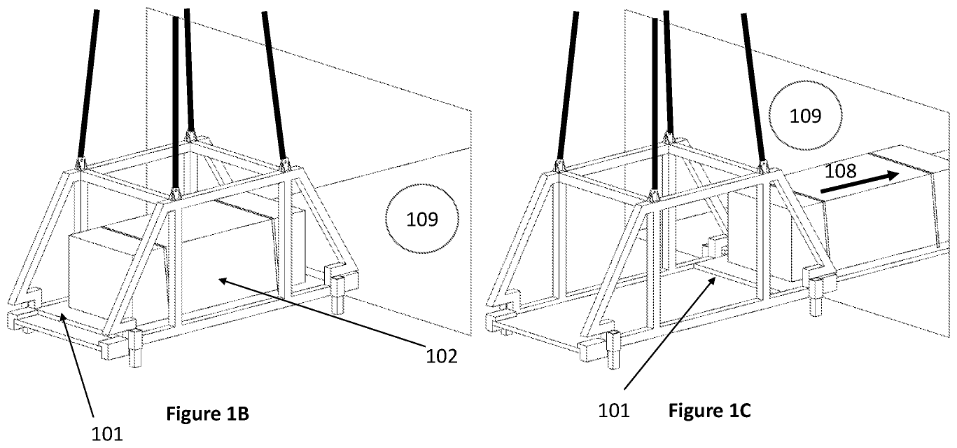

FIGS. 1A to 1C show an exemplary embodiment of a cradle structure 100 having a cradle 110 and a load bearing device, in this case a platform 101. The platform, in this case, is mounted on bearings (not shown) that is arranged to move from a first potion within the cradle 110 to a second position at least partly project outside the cradle, and relative to the cradle 110. The platform 101 acts as a load bearer that slides from the first position relative to the cradle, to a second position such that a payload 102 projects 108 from one of two open ends. The lifting rig is arranged to be lifted to an elevated space and the platform to move to the second position to release the payload within the elevated space.

The cradle may further include mounting fixtures arranged to couple to the elevated space, and so secure and/or stead the lifting rig while suspended. The mounting fixtures may be a simple dowel arrangement for sliding into apertures at the docking zone of an elevated space. Alternatively, the mounting fixtures may include beams arranged to project into the elevated space, such that the beams are designed to resist the weight of the lifting rig. In this embodiment, the beams can then support the lifting rig momentarily should the crane inadvertently lower the lifting rig. Thus, the mounting fixtures may also act as a safety feature

It will be appreciated that in some embodiments, having two ends may allow for the payload to enter on one side (perhaps at street level) and exit on the other (at the elevated location). In an alternative arrangement, the lifting rig may have only one open end, with the payload arranged to enter and exit from the same end.

It will be appreciated that, where only one open end is present, the other end includes blocks, plates or cross beams arranged to prevent the unintended exit of the payload. It will further be appreciated that the one or both open ends include selectively removable barriers, such as block, plates or crossbeams, to secure the load during transport.

The bearings arranged to facilitate the relative movement of the platform may be in the for of slides fixed between the platform and cradle. Alternatively, the platform may be free to move without fixtures, and so constrained by the sides of the cradle. The bearings may also be in the form of a two-dimensional array of ball bearings, either mounted to the platform or to the cradle. This may allow for both forward and lateral movement of the platform, relative to the cradle. This may therefore allow for incremental positioning of the payload as it exits the lifting rig, so as to facilitate alignment. The bearing array may also allow for incremental rotation, to solve rotational alignment issues.

Besides the platform, other moving parts of this embodiment include the mounting fixtures previously described. The mounting fixtures may further include docking legs 103 and stoppers 104. The docking legs and the stoppers may be pushed up when the cradle is put down on flat ground for loading or unloading the platform. The platform may be pulled out of the cradle for loading or unloading without encumbrance. A payload is placed on the platform by either using a crane or dollies, before being lashed 105 to the platform for hoisting by crane 106 in adherence to OSHA standard practice regulations. When the cradle is hoisted the stoppers drop to act as a block to prevent the platform from moving out of position during the lifting procedure. The docking legs also drop as the cradle is hoisted. The lifting crew guides the crane to position the cradle using the docking legs to abut the wall outside the roofed space 109 while hovering the tongue 107 of the cradle above the floor. Positioning the cradle raises the block on the platform allowing the crew to pull out the load by hand or using a winch. Lashing removal is safely done on the stable ground of the roofed space rather than on the suspended or cantilevered platform as before. A chain block mounted on the ceiling above the load can be used to lift the load before the platform is pushed back into the cradle. Alternatively, the load can be dollied off the platform.

In a still further embodiment, the platform may include an articulated conveyor arranged to first project the payload into the roofed space, and then progressively deliver the payload from the platform into the space.

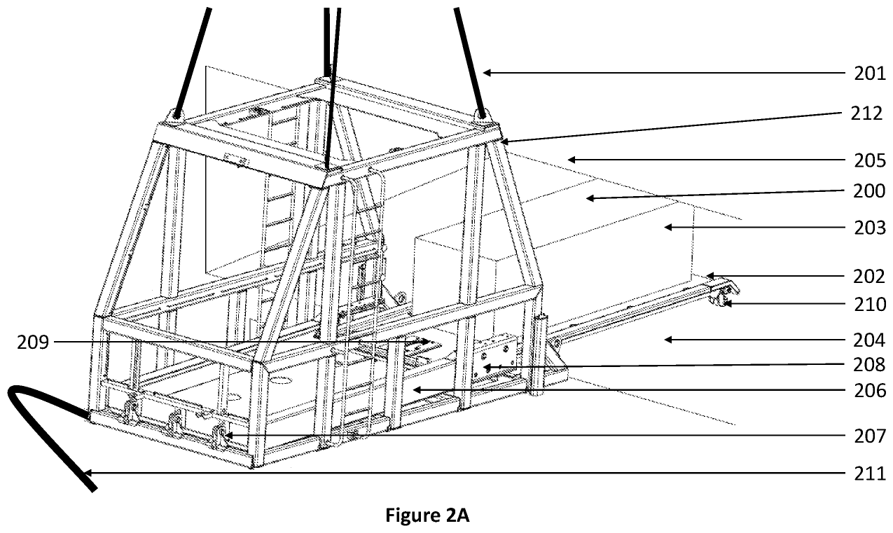

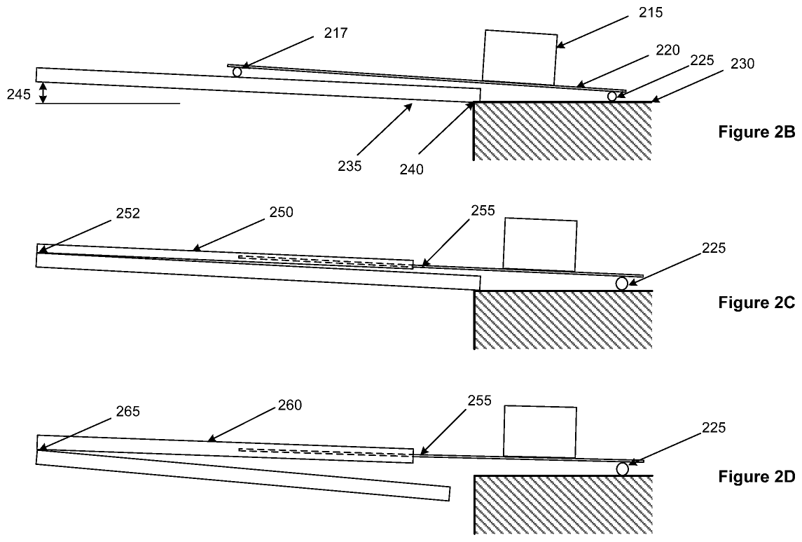

FIG. 2A shows an exemplary embodiment of the invention for large and heavy loads, where the cradle structure 200 is suspended by lifting gear 201 with a platform 202 to bear the load 203. The platform slides to transfer the load via the open end to or from the floor space 204, where direct lifting access is obstructed by a roof 205. The platform resides within the housing in sliding engagement, with the housing pivotally connected to the cradle 208. As the platform (with the payload) projects forward, the rigidity of the housing prevents the platform from bending, and so acts as a support during load transfer. Through the pivotal connection to the cradle, whilst the back end of the cradle will lift as the load is transferred, the housing has less inclination, with the rigidity of the housing accommodating the load distribution.

The inclusion of the housing insulates the platform from deformation caused to the cradle by the upward force of the crane, repeatedly acting over prolonged usage, on the cradle as the load transfers away from it and onto the roofed space. In conventional platforms, when the load transfers to the building, the pressure at the back is released causing the back part of the platform to lift up with the open side weighed down by the load—this may cause a prior art platform to bend.

For the present embodiment, the housing is pivot jointed to the cradle, and so the cradle resists the applied load without the application of a flexural load, which may otherwise bend and deform the cradle. This allows the back to lift up without damaging the cradle.

An electric motor 209 equipped with a brake is fitted to the platform and coupled to a rack and pinion based on the housing floor to drive the platform in and out of the housing. The motor brake prevents movement of the platform during hoisting. The platform has wheels 210 that support the load as the platform moves over the roofed floor. Electric power for the motor is supplied from the ground 211 from a multi directional extension attachment, such as the commercially available Deck Arrangement Tower for operations upon roofed spaces at lower reaches such as the first few floors of a building in construction or the deck of a vessel in harbour.

FIGS. 2B to 2D show various embodiments of the lifting rig and, in particular, how each embodiment is affected by the re-distribution of load as the payload is moved to the elevated space 230. In each embodiment, it is recognised that, as the payload 215 is moved from the cradle 235, there is a corresponding shift upwards 245 of the back end of the cradle 235.

In the first embodiment (FIG. 2B) the platform 220 is supported by wheels 225, 217 and so as the payload moves forward, the cradle supports the progressively moving load through the back wheel 217. It will be noted that, in this embodiment, the cradle 235 is supported 240 on the elevated space 230, with this support acting as a point of rotation of the back end.

In the second embodiment (FIG. 2C) the cradle includes a housing 250, similar to the embodiment of FIG. 2A. Here, the platform 255 is supported along its length as it projects forward. The housing acts to distribute the load to the pivot at the back of the cradle, and so the reaction force is always applied at the back 252, unlike the progressively moving reaction 217 of FIG. 2B. This may provide greater stability to the cradle, as compared to the moving reaction of FIG. 2B. Again, the cradle is supported at the front by the elevated space.

In the third embodiment (FIG. 2D), a similar arrangement is provided to that of FIG. 2C. Again, the platform 255 projects forward on a front wheel 225, however, the cradle is not supported at the front by the elevated space. Thus, the cradle is wholly supported by the crane. To achieve this arrangement, it may be necessary to have a more rigid housing 260 to accommodate the load distribution at the back 265. This embodiment presents several advantages in that it is faster to implement, as the front support isn't required, and lateral rotation about a front support may be eliminated.

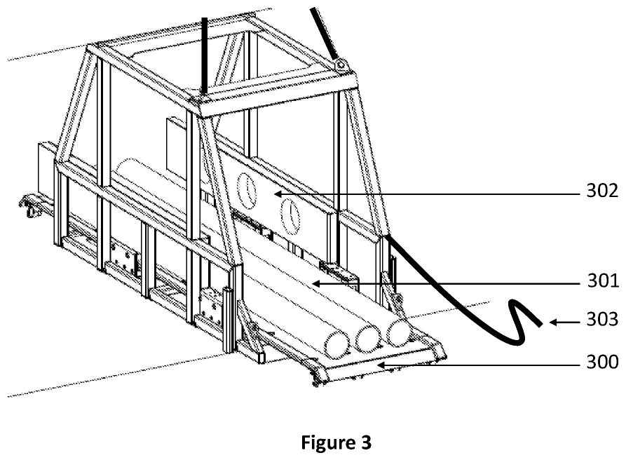

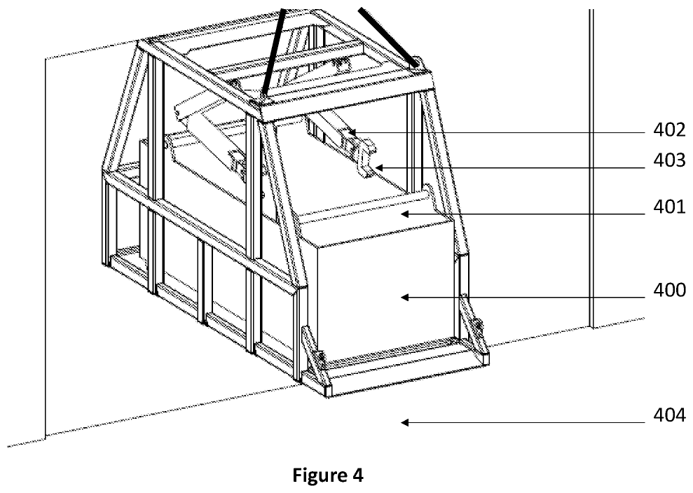

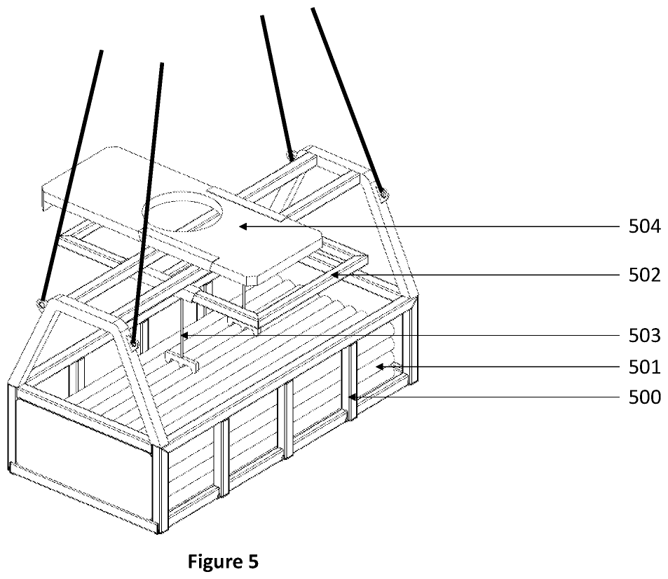

FIGS. 3 shows an embodiment of the invention with two open ends, and an elongate sliding platform 300 to bear long loads such as pipes or bundled rods 301. Sliding counterweights 302 are manipulated to balance the weight as the payload is transferred on and off the cradle. The lifting rig may further include a control system having a balance feedback including a plurality of accelerometers, such that if the platform exceeds a pre-determined inclination, the control system is arranged to autonomously, or semi-autonomous on instruction from an operator, to move the counterweights so as to correct the over-inclination. In a further embodiment, there may be at least two movable counterweights arranged to move along orthogonal horizontal axes, such that movement of the counterweights is arranged to overcome over-inclination about two horizontal principal axes. The lifting rig according to the present invention may include sensors, sirens and crew alerts for correctness and changes in weight, height, alignment, level, and stability.

Electrical power may come from within the building using a quick coupling and uncoupling socket. Power sockets with an extension wire 303 are provided within safe reach at both ends to couple with power source at loading and discharge points. Alternatively, power may be provided from the crane via the lifting cables. In cases where the lifting rig is large enough, the lifting rig may further include a generator so as to be power autonomous.

FIG. 4 shows another embodiment of the invention that is suited for conveying standardized bins 400 on wheels and with lifting bar 401 to and from roofed spaces. Such containers may speed up the transfer of loose material and construction debris. Articulating booms 402 act as a load transfer means. Hardened claws 403 at ends of the respective booms lift the front of the bin before pushing the bin out of the cradle and onto the roofed floor 404 at higher levels of the building. Vice versa, for the reverse operation.

FIG. 5 shows another embodiment of the invention that is suited for conveying a multitude of heavy material like pipes. The cradle walls 500 form a basket to keep the load 501 safe from coming out of the cradle, and so prevent the payload from prematurely exiting the cradle.

A telescopic boom 502 with grabs 503, such as mechanical or magnetic grabs, may be used in conjunction with a counterweight 504 to transfer the material back and forth between the cradle and the roofed floor space. Said telescopic boom may rely upon the counterweight for balancing the telescopic boom, and cradle, as the payload is moving between the elevated space and the cradle.

All embodiments of the invention can be equipped with useful technological attachments such collision sensors and measurement devices like inclinometers.

Monitoring, guidance, and communication aids can also be packaged into a crew coordination system which allows the crane operator to have audio-visual contact with the crew at the loading and discharge points, and the benefit of seeing the operations live.

1. A lifting rig comprising:
a cradle and a load transfer device;
the load transfer device is arranged to draw in a payload to the cradle or deliver a payload from the cradle;
said lifting rig is arranged to be lifted to an elevated space and the load transfer device arranged to draw in or deliver the payload within the elevated space.

2. The lifting rig according to claim 1, further including mounting fixtures arranged to couple the cradle to the elevated space.

3. The lifting rig according to claim 1, wherein the load transfer device includes a platform arranged to fit within the cradle, said platform further arranged to move relative to the cradle to move from a first potion, within the cradle, to a second position at least partly, projecting from the cradle.

4. The lifting rig according to claim 3, wherein the platform is in sliding engagement with a housing, with the housing pivotally connected to an end of the cradle, such that as the platform moves relative to the cradle, at least a part of an applied load from the platform is supported at the end of the cradle.

5. The lifting rig according to claim 1, wherein the payload includes a bin and the load transfer device includes articulating booms arranged to engage the bin.

6. The lifting rig according to claim 5, wherein the articulating booms include claws, said claws arranged to engage the bin to deliver or draw in said bin.

7. The lifting rig according to claim 1, further including at least one movable counterweight and a control system having a balance feedback, such that if the cradle exceeds a pre-determined inclination, the control system is arranged to move the counterweights so as to correct the over-inclination.

4. The lifting rig according to claim 7, further including at least one sensor in data communication with the control system, said sensor arranged to measure inclination of the cradle and communicate said data to the control system.

5. The lifting rig according to claim 7, wherein there are at least two movable counterweights arranged to move along orthogonal horizontal axes.

10. The lifting rig according to claim 1, wherein the cradle includes walls forming a basket, said basket arranged to prevent the payload from prematurely exiting the cradle.

11. The lifting rig according to claim 1, wherein the load transfer device includes a telescopic boom, said telescopic boom having grabs for engaging the payload and a counterweight for balancing the telescopic boom and cradle, as the payload is moving between the elevated space and the cradle.

12. A method for lifting a payload to an elevated space, the method comprising the steps of:
drawing in a payload to a cradle by a load transfer device mounted therein;
lifting the cradle from a first level to the elevated space;
delivering the payload to the elevated space by the load transfer device.
